(19) United States
(12) Patent Application Publication
(10) Pub. No.: US 2004/0256366 A1
(43) Pub. Date: Dec. 23, 2004

(54) Welding device of fuel tank for vehicle and welding method thereof

(75) Inventors: Yong-Man Kim, Gyeongsangnam-do (KR); Han-Min Kim, Ulsan Metropolitan City (KR); Ki-Yong Kim, Ulsan Metropolitan City (KR)

Correspondence Address: William R. McClellan, Wolf, Greenfield & Sacks, P.C., 600 Atlantic Avenue, Boston, MA, 02210, US

(73) Assignee: Donghee Industrial Co., Ltd., Ulsan Metropolitan City (KR)

(21) Appl. No.: 10/748,380

(22) Filed: Dec. 30, 2003

(30) Foreign Application Priority Data
Jun. 18, 2003 (KR) 10-2003-0039467

(51) Int. Cl. B23K 26/28; B23K 26/42

(52) U.S. Cl. 219/121.63; 219/121.64; 219/121.82

(57) ABSTRACT

Disclosed are a welding device of a fuel tank for vehicles, which welds flanges of upper and lower panels of the fuel tank together by pressing and melting using a laser, and a welding method thereof The welding device includes a feed unit for holding upper and lower panels of the fuel tank provided with flanges formed at edges thereof under the condition that the flanges are stacked, and for transferring the upper and lower panels in a horizontal direction; a pressure unit for pressing the flanges of the upper and lower panels, transferred by the feed unit, at front and rear portions of at front and rear portions, and for guiding the transfer of the upper and lower panels; and a laser beam generator perpendicularly separated from central portions of the flanges pressed by the pressure unit by a designated interval, for irradiating a laser beam to the upper and lower panels so that the flanges of the upper and lower panels are fusion-welded together by using heat generated from the irradiated laser beam. The welding device employing laser beam welding allows a heat source not to contact a basic material of the fuel tank, thus not requiring replacement of electrodes and reducing the cost of production. Further, the welding device allows the flanges to be welded by sequentially pressing and melting the flanges, thus improving weldability.

### FIELD OF THE INVENTION

The present invention relates to a welding device of a fuel tank for vehicles and a welding method thereof and, more particularly, to a welding device of a fuel tank for welding together flanges of upper and lower panels of the fuel tank by vertically pressing and melting the flanges of the upper and lower panels by using a laser, and a welding method thereof

### BACKGROUND OF THE INVENTION

In general, every vehicle is provided with a fuel tank for storing a designated quantity of fuel in order to continuously supply the fuel to an engine.

A conventional fuel tank for vehicles comprises upper and lower panels, which are adhered to each other by welding. The upper and lower panels have symmetrical structures, and flanges respectively formed at edges of the upper and lower panels contact each other and are then welded together.

Seam welding has been mainly used to adhere the upper and lower panels of the conventional fuel tank. In seam welding, which is a type of electrical resistance welding, the flanges of the upper and lower panels are inserted into a pair of electrode rollers having a circular shape under the condition that portions of both panels to be adhered are overlapped, thereby being continuously line-welded in accordance with the rotation of the rollers.

Here, the electrode rollers serve to transfer the panels, and simultaneously serve as seam electrodes.

The above seam welding using a seam welding machine is mainly applied to a seam required to be air or oil-sealed tightly, thus being advantageous in adhering the upper and lower panels of the fuel tank together. However, since the electrode rollers are easily worn away by friction generated between the electrode rollers serving as the seam electrodes and the panels, the electrode rollers need to be replaced frequently by a new roller, thus causing an increase in the cost of materials and cost of production.

Further, if the contact surfaces of the flanges of the upper and lower panels are uneven, the quality of welding is reduced, and the contact area between the electrodes and the panels is larger than the contact areas obtained by using other welding methods, thereby being easily thermally deformed and causing cracks thereon due to a flow of fuel and external impact.

Accordingly, alternative welding methods have been proposed for connecting the upper and lower panels of a fuel tank for vehicles, rather than using the seam welding method. U.S. Pat. No. 5,626,776 discloses a patent entitled “Flangeless Fuel Tank”. As shown in FIGS. 5 and 6, a fuel tank 10, which is disclosed by the above patent, comprises upper and lower flangeless panels 12 and 14 having a symmetrical structure, and side walls 16 and 18 respectively extended from the upper and lower panels 12 and 14, overlapped and welded to each other along overlapped portions so that the side walls 16 and 18 are integrated into one unit.

Further, the upper and lower panels 12 and 14 respectively include formed units 20 and 22 provided with a plurality of protrusions 20 and 22 and a plurality of concaves 30, thereby being fixed at designated positions prior to welding.

The upper and lower panels 12 and 14 are fusion-welded together by means of heat generated from a laser beam irradiated on connecting portions of the upper and lower panels 12 and 14.

In conventional welding using the laser beam, adhesion capability between the panels depends on the formed units of the panels to be welded. However, since this welding is not equipped with any additional apparatus coping with the thermal deformation generated in laser welding and a recent fuel tank for vehicles comprises several functional structures installed therein so that the fuel tank requires a complicated structure, the conventional flangeless fuel tank does not satisfy requirement that it be of diverse shape.

### SUMMARY OF THE INVENTION

The present invention has been made in view of the above drawbacks, and it is an object of the present invention to provide a welding device of a fuel tank for vehicles, which solves problems caused by the conventional seam welding having a large contact area between electrodes and a basic material, prevents thermal deformation of panels caused by the conventional laser beam welding, and satisfies the requirement that the fuel tank be of diverse shape, and a welding method thereof.

In accordance with one aspect of the present invention, the welding device of a fuel tank for vehicles comprises: a feed unit for holding upper and lower panels of the fuel tank provided with flanges formed at edges thereof under the condition that the flanges are stacked, and for transferring the upper and lower panels in a horizontal direction; a pressure unit for pressing the flanges of the upper and lower panels, transferred by the feed unit, at front and rear portions, and for guiding the transfer of the upper and lower panels; and a laser beam generator positioned perpendicularly from central portions of the flanges pressed by the pressure unit with a designated interval, for irradiating a laser beam to the upper and lower panels so that the flanges of the upper and lower panels are fusion-welded together by using heat generated from the irradiated laser beam.

Preferably, the feed unit may include a main body provided with a power source mounted thereon; a power transmission unit extended from an upper portion of the main body for transmitting a driving force generated from the power source of the main body; a holding unit connected to an end of the power transmission unit for holding the upper and lower surfaces of the upper and lower panels, and for allowing the upper and lower panels to be rotated toward the pressure unit; and a control unit for controlling the operation of the holding unit.

Further, the pressure unit may preferably include a pressure jig separated from the feed unit by a designated distance; first and second pressure members installed at one side of the pressure jig so that they cause a rolling motion, and spaced apart from each other by a designated distance such that they contact the flange of the lower panel in transferring the flanges; third and fourth pressure members located correspondingly above the first and second pressure members such that they contact the upper panel; and a pressure portion for elevating and lowering the third and fourth pressure members, and for supplying suitable pressure to the upper panel when it contacts the upper panel.

Moreover, the first, second, third and fourth pressure members preferably may be ball casters.

Preferably, the pressure portion may include first and second pressure bars respectively connected to the third and fourth pressure members; rods respectively connected to the first and second pressure bars; and cylinders activated by supply of hydraulic or pneumatic pressure for respectively elevating and lowering the rods.

In accordance with another aspect of the present invention, there is provided a welding method of a fuel tank for vehicles comprising the steps of: (a) holding upper and lower panels of the fuel tank, having a symmetrical structure, provided with flanges formed at edges thereof so that the upper and lower panels are stacked; (b) transferring the flanges of the held upper and lower panels in a horizontal direction; (c) guiding the transfer of the flanges of the upper and lower panels when the flanges are transferred, and simultaneously applying suitable pressure to the flanges of the upper and lower panels at front and rear portions so that the flanges are adhered closely together; and (d) irradiating a laser beam from the upside of the flange of the upper panel to central portions of the flanges of the upper and lower panels so that the flanges are fusion-welded together by using heat generated from the irradiated laser beam.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front view of a welding device of a fuel tank for vehicles using a laser in accordance with the present invention;

FIG. 2 is an enlarged view of an essential part of the welding device of FIG. 1;

FIG. 3 is a perspective view of the welding device, in which flanges are pressed prior to welding, in accordance with the present invention;

FIG. 4 is a schematic view illustrating a welding method of a fuel tank using the welding device of the present invention;

FIG. 5 is a schematic view of a fuel tank welded with a conventional laser; and

FIG. 6 is a cross-sectional view illustrating connection between essential parts in FIG. 5.

### DESCRIPTION OF THE PREFERRED EMBODIMENTS

The preferred embodiments of the present invention will now be described in detail with reference to the annexed drawings.

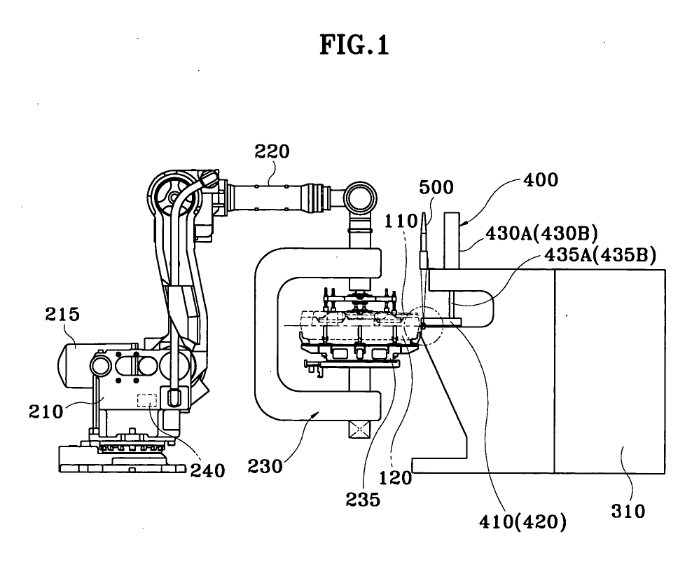

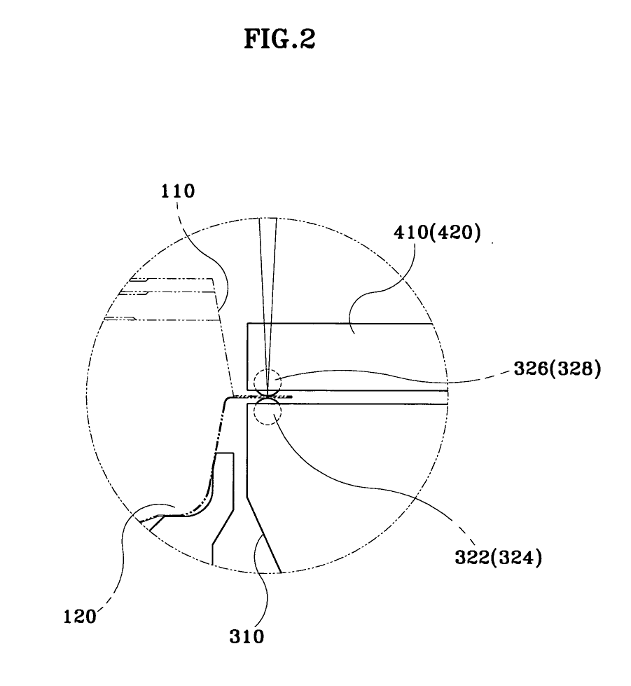

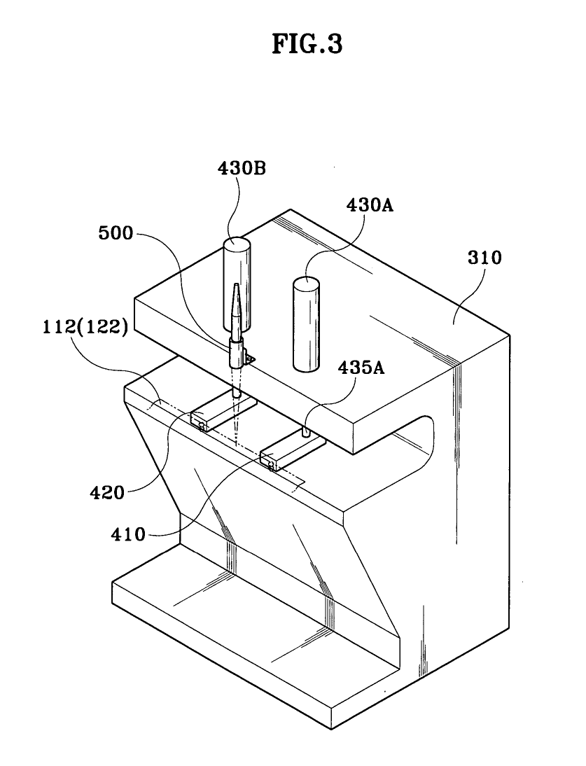

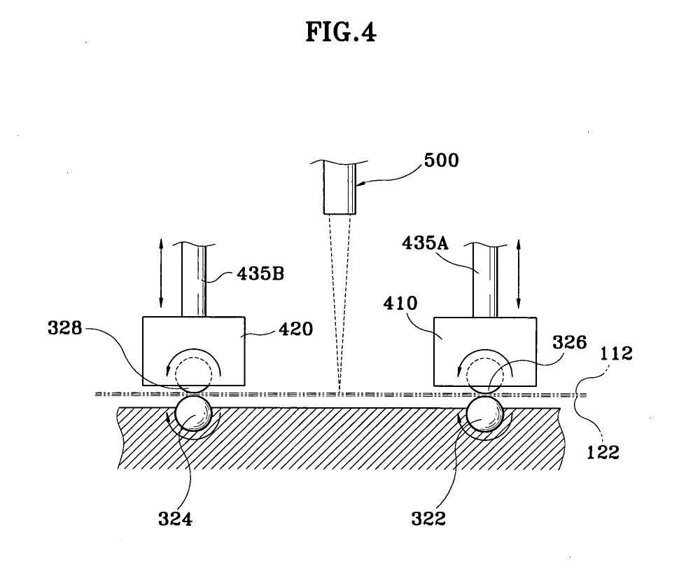

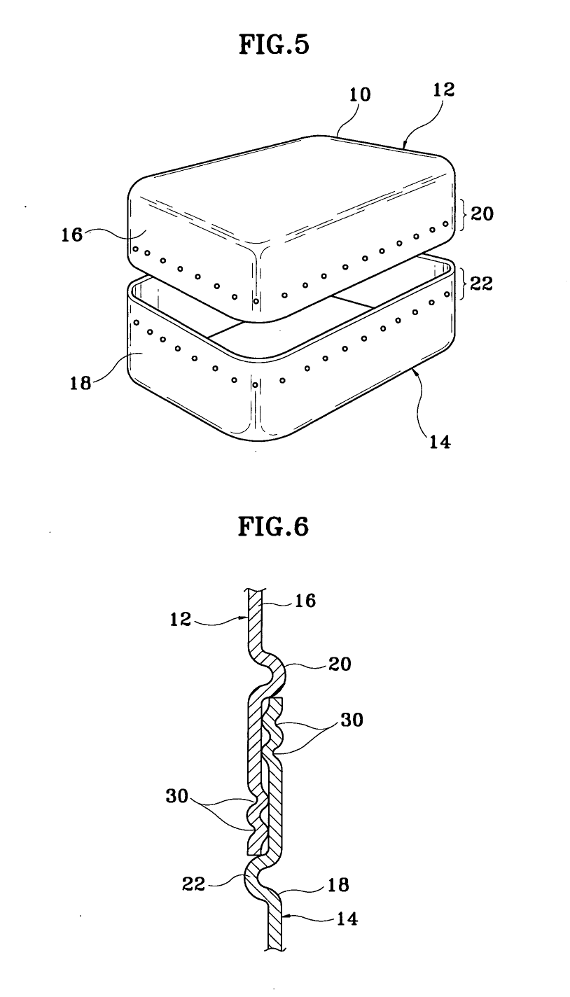

As shown in FIGS. 1 to 4, a welding device of a fuel tank for vehicles of the present invention comprises: a feed unit for holding upper and lower surfaces of upper and lower panels 110 and 120 provided with flanges 112 and 122 having a symmetrical shape formed at edges of the upper and lower panels 110 and 120, and for transferring the upper and lower panels 110 and 120 along a straight or curved weld line; a pressure unit for pressing the flanges 112 and 122 of the upper and lower panels 110 and 120, transferred by the feed unit, at front and rear portions, and for guiding the transfer of the upper and lower panels 110 and 120; and a laser beam generator 500 arranged on a central portion of the pressure unit, perpendicular to the upper panel 110, for irradiating a laser beam onto the upper panel 110 so that the flanges 112 and 122 of the upper and lower panels 110 and 120 are fusion-welded by using heat generated by the irradiated laser beam.

More specifically, the feed unit includes a holding unit 230 for holding the upper and lower sides of the upper and lower panels 110 and 120, and for allowing the held upper and lower panels 110 and 120 to be rotated by means of a turn table 235 arranged under the lower panel 120; a power transmission unit 220 extended from an upper portion of the holding unit 230 for transmitting a driving force generated from a main body 210 provided with a power source 215 such as a motor; and a control unit 240 located in the main body 210 for controlling operation of the holding unit 230.

The pressure unit includes a pressure jig 310 separated from the holding unit 230 by a designated distance, first and second pressure members 322 and 324 located at one side of the pressure jig 310 and spaced apart from each other by a designated distance such that they contact the flange 122 of the lower panel 120, third and fourth pressure members 326 and 328 located above the first and second pressure members 322 and 324 and spaced apart from each other by a designated distance such that they contact the flange 112 of the upper panel 110 and go up and down, and a pressure portion 400 located on upper surfaces of the third and fourth pressure members 326 and 328 for supplying pressure.

The pressure portion 400 includes first and second pressure bars 410 and 420 respectively connected to upper portions of the third and fourth pressure members 326 and 328, rods 435A and 435B respectively connected to the first and second pressure bars 410 and 420, and pneumatic or hydraulic cylinders 430A and 430B for respectively supplying pressure to the third and fourth pressure members 326 and 328.

The first, second, third and fourth pressure members 322, 324, 326 and 328 are designed such that they respectively contact front and rear portions of the upper and lower surfaces of the flanges 112 and 122 of the upper and lower panels 110 and 120 so as to achieve a rolling motion. Preferably, the first, second, third and fourth pressure members 322, 324, 326 and 328 employ ball casters. However, the first, second, third and fourth pressure members 322, 324, 326 and 328 may employ other rollers rather than the ball casters.

That is, the first and second pressure members 322 and 324 are fixed at one side of the pressure jig 310 such that they achieve rolling motion in order to guide the transfer of the flanges 112 and 122. The third and fourth pressure members 326 and 328 go up and down by the operation of the pneumatic or hydraulic cylinders 430A and 430B, and contact the flange 112 of the upper panel 110 in going down so that they apply pressure to the stacked flanges 112 and 122 of the upper and lower panels 110 and 120.

The laser beam generator 500 is located above an area between the third and fourth pressure members 326 and 328, perpendicular to the upper panel 110, and serves to irradiate a laser beam to the area between the third and fourth pressure members 326 and 328.

Preferably, the control unit 240 controls operations of the laser beam generator 500, the cylinders 430A and 430B and the holding unit 230 such that the operations of the laser beam generator 500 and the cylinders 430A and 430B are linked with the operation of the holding unit 230.

Here, non-described reference numeral 510 represents a bracket for fixing the pneumatic or hydraulic cylinders 430A and 430B to the pressure jig 310.

Hereinafter, a welding method of a fuel tank for vehicles using the above-described welding device of the present invention will be described in detail.

The holding unit 230 holds the flanges 112 and 122 of the upper and lower panels 110 and 120 of the fuel tank under the condition that the flange 112 of the upper panel 110 is stacked on the flange 122 of the lower panel 120. Then, the stacked flanges 112 and 112 are transferred in a horizontal direction such that they continuously pass through a gap between the first and third pressure members 322 and 326 and a gap between the second and fourth pressure members 324 and 328.

Here, when the upper and lower panels 110 and 120 are rotated by the turn table 235 of the holding unit 230, the flanges 112 and 12 continuously pass through the gap between the first and third pressure members 322 and 326 and the gap between the second and fourth pressure members 324 and 328. At this time, the flange 112 of the upper panel 1120 is pressed down by the third and fourth pressure members 326 and 328 by operations of the cylinders 430A and 430B, and is then closely adhered to the flange 122 of the lower panel 120. The first and second pressure bars 410 and 420 go down by the operations of the cylinders 430A and 430B, thereby causing the third and fourth pressure members 326 and 328 to go down so that the flanges 112 and 122 of the upper and lower panels 110 and 120 are adhered closely to each other.

The flanges 112 and 122 of the upper and lower panels 110 and 120 are horizontally transferred by the rotation of the upper and lower panels 110 and 120 by means of the holding unit 230. The first, second, third and fourth pressure members 322, 324, 326 and 328 adhere the flanges 112 and 122 of the upper and lower panels 110 and 120 closely together so as to improve the weldability between the flanges 112 and 122.

Thereafter, the laser beam generator 500 perpendicularly irradiates a laser beam to the flanges 112 and 122, and the flanges 112 and 122 are melted and adhered closely together by heat generated by the irradiated laser beam having a high convergence.

Further, when the flanges 112 and 122 enter the gap between the first and third pressure members 322 and 326 and the gap between the second and fourth pressure members 324 and 328, the third and fourth pressure members 326 and 328 may go up, thereby preventing interference between the flanges 112 and 122 and the third and fourth pressure members 326 and 328. After the welding of the flanges 112 and 122 is completed, the third and fourth pressure members 326 and 328 may go up again, thereby allowing the flanges 112 and 122 to be separated from the third and fourth pressure members 326 and 328.

As apparent from the above description, the present invention provides a welding device of a fuel tank for vehicles using a laser, in which upper and lower panels of the fuel tank provided with flanges are welded and the flanges are adhered to each other by pressing, and a welding method thereof, thereby improving weldability. The welding device of the present invention employing laser beam welding does not contact a basic material of the fuel tank, thus not requiring replacement of electrodes and reducing the cost of production. Further, the welding device of the present invention allows the flanges to be welded by sequentially pressing and then fusing the flanges, thus improving weldability.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A welding device of a fuel tank for vehicles, comprising:
a feed unit for holding upper and lower panels of the fuel tank provided with flanges formed at edges thereof under the condition that said flanges are stacked, and for transferring said upper and lower panels in a horizontal direction;
a pressure unit for pressing said flanges of said upper and lower panels, transferred by said feed unit, at front and rear portions, and for guiding the transfer of said upper and lower panels; and
a laser beam generator perpendicularly positioned from central portions of said flanges pressed by said pressure unit with a designated interval, for irradiating a laser beam to said upper and lower panels so that said flanges of said upper and lower panels are fusion-welded together by using heat generated from the irradiated laser beam.

2. The welding device as defined in claim 1, wherein said feed unit comprises:
a main body provided with a power source mounted thereon;
a power transmission unit extended from an upper portion of said main body for transmitting a driving force generated from the power source of said main body;
a holding unit connected to an end of said power transmission unit for holding the upper and lower surfaces of said upper and lower panels, and for allowing said upper and lower panels to be rotated toward said pressure unit; and
a control unit for controlling the operation of said holding unit.

3. The welding device as defined in claim 1 or 2, wherein said pressure unit comprises:
a pressure jig separated from said feed unit by a designated distance;
first and second pressure members installed at one side of said pressure jig so that they cause a rolling motion, and spaced apart from each other by a designated distance such that they contact said flange of said lower panel in transferring said flanges;
third and fourth pressure members located correspondingly above said first and second pressure members such that they contact said upper panel; and
a pressure portion for elevating and lowering said third and fourth pressure members, and for supplying suitable pressure to said upper panel when it contacts said upper panel.

4. The welding device as defined in claim 3, wherein said first, second, third and fourth pressure members are ball casters.

5. The welding device as defined in claim 3, wherein said pressure portion comprises:
first and second pressure bars respectively connected to said third and fourth pressure members;
rods respectively connected to said first and second pressure bars; and
cylinders activated by supply of hydraulic or pneumatic pressure for respectively elevating and lowering said rods.

6. A welding method of a fuel tank for vehicles, comprising the steps of:
holding upper and lower panels of said fuel tank, having a symmetrical structure, provided with flanges formed at edges thereof so that said upper and lower panels are stacked;
transferring said flanges of said held upper and lower panels in a horizontal direction;
guiding the transfer of said flanges of said upper and lower panels when said flanges are transferred, and simultaneously applying suitable pressure to said flanges of said upper and lower panels at front and rear portions so that said flanges are adhered closely to each other; and
irradiating a laser beam from the upside of said flange of said upper panel to central portions of said flanges of said upper and lower panels so that said flanges are fusion-welded together by using heat generated from the irradiated laser beam.
